(19) United States
(12) Patent Application Publication
(10) Pub. No.: US 2005/0236789 A1
(43) Pub. Date: Oct. 27, 2005

(54) Cylindrical tank boot

(75) Inventors: Derek C. Knox, Lehi, UT (US); Patrick M. Byrne, Salt Lake City, UT (US)

Correspondence Address: ALAN J. HOWARTH, P.O. BOX 1909, SANDY, UT, 84091-1909, US

(73) Assignee: Overstock.com, Inc.

(21) Appl. No.: 10/833,459

(22) Filed: Apr. 27, 2004

(51) Int. Cl. B62B 1/00

(52) U.S. Cl. 280/79.5

(57) ABSTRACT

A tank boot attachable to the bottom end of a cylindrical tank having at least one storage compartment, which may be watertight, is disclosed. The storage compartments may be used to store a wide range of useful items, as a housing for a power supply for a light source, or as a repository for a printed insert. The boot may comprise a transparent portion for allowing the contents of a storage compartment, such as a printed insert, or light from the light source to be viewed externally. The tank boot may comprise a pair of wheels movable between a first position and a second position for facilitating the transport of the cylindrical tank.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present disclosure relates generally to transporting and protecting elongated cylindrical tanks, and more particularly, but not necessarily entirely, to devices attachable to the lower end of cylindrical tanks.

Tank boots, also referred to as caps, for protecting the bottom ends of cylindrical tanks and for facilitating transport of the tanks have been in use for many years. Typically, a boot fits snugly over the bottom end of a tank and may provide a stable base to support the tank in an upright position. Tank boots are generally made of a resilient material such as thermoplastic or rubber that snugly grips the bottom end of the tank by suction or friction. While tank boots can be deployed on a wide range of cylindrical tanks, tank boots are often used on scuba tanks due to the fact that the scuba tanks are commonly transported across rough ground to reach the dive location and the fact that they are extremely heavy even when empty. The boot may remain on the tank during a dive.

One improvement upon a basic tank boot is disclosed in U.S. Pat. No. 3,809,353, granted to Good et al., which discloses a tank boot having a ribbed sidewall that grips a scuba tank. Channels formed between the ribs allow water to drain freely so that the boot does not need to be removed from the tank after a dive.

More recent improvements to tank boots include attaching an axle and a roller to the boot as disclosed in U.S. Pat. No. 5,292,140 granted to Laing. The roller allows a person to easily relocate and control a heavy tank without having to lift the tank or use a separate transport device. The Laing device is especially suited for scuba tanks as the roller wheel is designed for movement across soft surfaces, such as sand. Another wheeled device for transporting tanks is disclosed in U.S. Pat. No. 5,131,670 granted to Clements et al. This device comprises two wheels mounted on an axle and a pair of tank-engaging members. While not a boot per se, the device does attach to the bottom end of a tank. The device is collapsible, making it more convenient to store. Other non-boot type devices have also been used in the past for transporting scuba tanks to the dive location. For example, U.S. Pat. No. 5,393,080, granted to Ross, and U.S. Pat. No. 4,815,761, granted to Henderson et al., both disclose dolly-type devices for transporting scuba tanks. These devices are typically detached from the tank during use and may serve other functions such as a dive work platform.

Despite the advantages of known tank boots and other transport devices, improvements are still being sought. For example, it would be beneficial to provide a tank boot with one or more storage compartments. The storage compartments, if watertight, could be used for a wide range of purposes including storing personal valuables during a dive such as cellular phones, car keys, and wallets. In addition, the compartments could be used for storing a tool kit, spare tank parts, or a first aid kit. The storage compartments could also be used as specimen containers or as the location for a sensor for recording information about the dive or for a transmitter.

Another example of an improvement over the prior art would be an inclusion of a power supply and a light source in a tank boot. This would allow divers to keep track of one another while diving, especially from behind. In addition, external electrical devices could be connected to the power supply. Still another improvement would be a tank boot having a transparent portion thereby allowing items in a storage compartment, such as a printed insert or light from a light source, to be externally viewable.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE SEVERAL VIEWS OF THE DRAWINGS

The features and advantages of the disclosure will become apparent from a consideration of the subsequent detailed description presented in connection with the accompanying drawings in which:

FIG. 1 is a perspective view of a tank boot made in accordance with the principles of the present invention;

FIG. 2 is a top view of the tank boot of FIG. 1;

FIG. 3A is a perspective view of a removable compartment;

FIG. 3B is a side view of the tank boot of FIG. 1 and removable compartment.

FIG. 4 is a sectional view of the tank boot of FIG. 1, taken along section A-A shown in FIG. 2;

FIG. 5 is a sectional view of the tank boot of FIG. 1, taken along section B-B shown in FIG. 4;

FIG. 6 is a bottom view of the tank boot of FIG. 1;

FIG. 7 is a sectional side view of an exemplary embodiment of a tank boot in accordance with the principles of the present invention;

FIG. 8 is a perspective view of a removable storage compartment having a lid;

FIG. 9 is a perspective view of a tank boot having a compartment having a door shown in a closed position;

FIG. 10 is a perspective view of the tank boot in FIG. 9 showing the door in an open position;

FIG. 11 is a bottom view of the tank boot in FIG. 9;

FIG. 11A is a break-away view of a user's hand holding the tank boot in FIG. 9;

FIG. 12 is a perspective view of another embodiment of a tank boot having of a removable compartment;

FIG. 13 is a top view of the removable compartment shown in FIG. 12;

FIG. 14 is a rear view of the removable compartment shown in FIG. 12;

FIG. 15 is a perspective view of another embodiment of a tank boot having retractable wheels;

FIG. 16 is a rear perspective view of the tank boot shown in FIG. 15;

FIG. 17 is a bottom view of the tank boot shown in FIG. 15 with the wheels in an extended position;

FIG. 18 is a bottom view of the tank boot shown in FIG. 15 with the wheels in a retracted position;

FIG. 19 is a bottom view of a tank boot with wheels in a retracted position;

FIG. 20 is a bottom view of the tank boot shown in FIG. 19 with the wheels in an extended position; and

FIG. 21 is a exploded view of a wheel assembly.

### DETAILED DESCRIPTION OF THE INVENTION

For the purposes of promoting an understanding of the principles in accordance with the disclosure, reference will now be made to the embodiments illustrated in the drawings and specific language will be used to describe them. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Applicant has invented a tank boot for cylindrical tanks having many useful features, especially when mounted on a scuba tank. Applicant's invention provides one or more storage compartments that may be watertight, thereby allowing items of importance to be stored safely and conveniently while diving. An illustrative embodiment of the invention is also unique in that it provides a power supply and a light source contained in a tank boot. In addition, the invention also provides a self-draining tank boot, thereby preventing the accumulation of excess water in the boot. Another aspect of the invention provides a tank boot with a transparent portion, thereby permitting items in a storage compartment to be viewed externally.

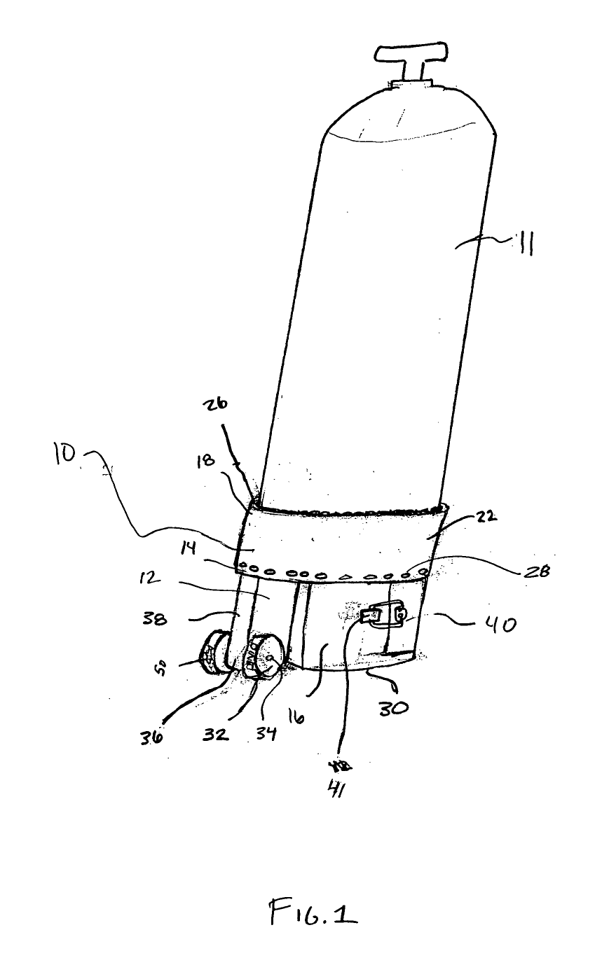

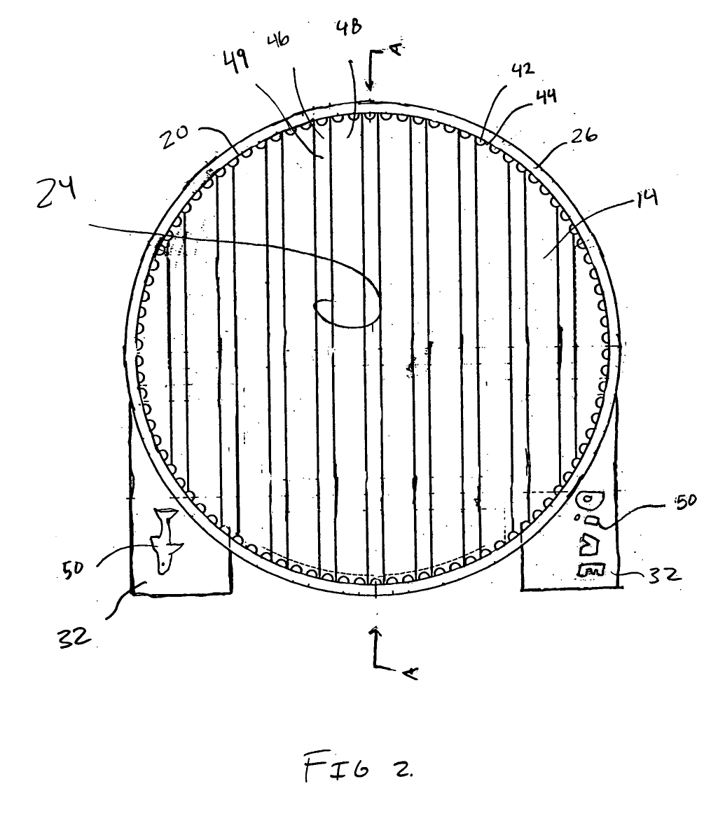

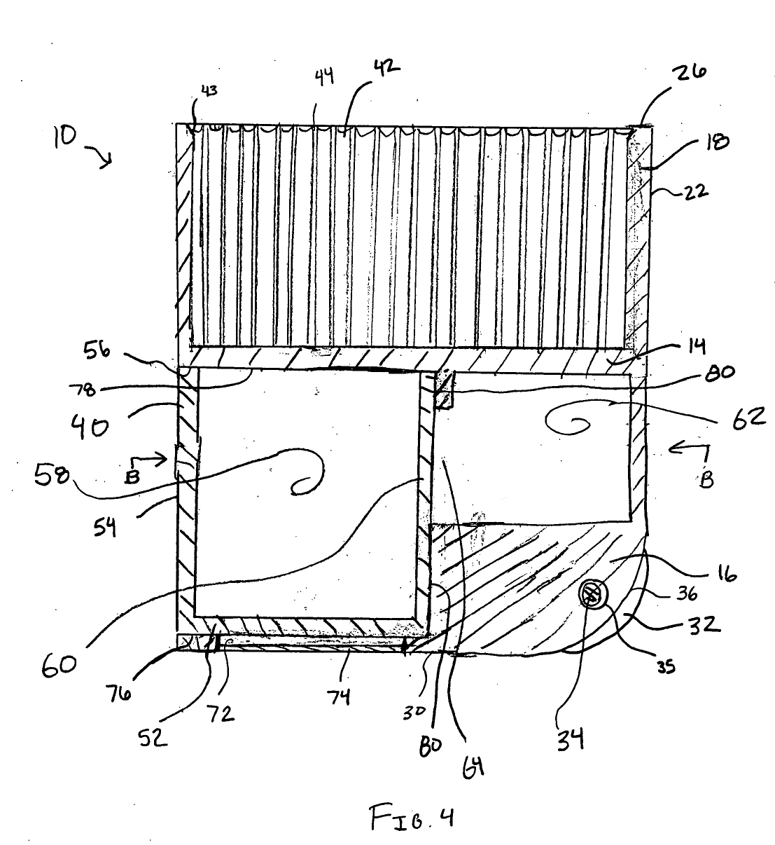

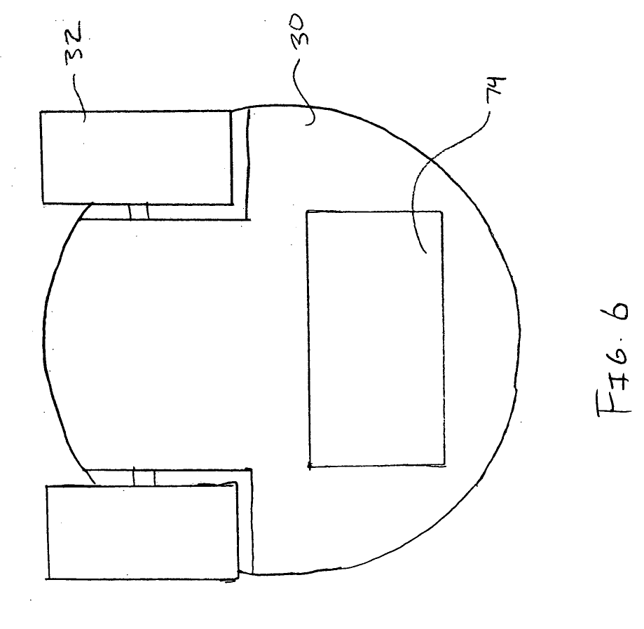

Referring now to the drawings, there is shown in FIGS. 1-6 a tank boot 10 in accordance with one exemplary embodiment of the present invention mounted on a cylindrical tank 11. The tank boot 10 has a generally cylindrical profile when observed from the side as shown in FIG. 4 and a generally circular profile when viewed from the top or bottom as shown in FIG. 2 and FIG. 6, respectively.

Referring now to FIG. 1, the tank boot 10 comprises a base member 12 having an upper portion 14 and a lower portion 16. Extending upwardly from the upper portion 14 is a wall 18 circumscribing the upper portion 14 around its perimeter. The upper portion 14 and the wall 18 define a cylindrically shaped cavity 24 (see FIG. 2) for receiving the bottom end of the cylindrical tank 11. The thickness of the wall 18 is relatively small in comparison to the height of the wall 18. A topmost portion 26 of the wall 18 forms a circular opening for receiving the cylindrical tank 11 as may be best observed in FIG. 2. The diameter of the cylindrical cavity 24 formed by wall 18 is typically slightly smaller than the diameter of the cylindrical tank 11 which the boot 10 is intended to fit. The tank boot 10 is installed by warming it, which causes it to expand sufficiently to receive the cylindrical tank 11 in the cavity 24. After installation, the tank boot 10 is cooled, which causes it to contract and grip the cylindrical tank 11 securely. It will be appreciated by those skilled in the art that the diameter of the cavity 24 may be varied in order to accommodate the variously sized tanks presently on the market.

The wall 18 is preferably constructed of a resilient material such that when the tank 11 is installed into the cavity 24, the wall 18 expands in a radial direction and snugly grips the tank 11 thereby holding the boot 10 onto the tank 11 by a friction fit. The resilient nature of the wall 18 permits the boot 10 to conform to slightly different sized tanks without modification.

Ports 28 extending from an inner surface 20 (see FIG. 2) of the wall 18 to an outer surface 22 of the wall 18 are shown in FIG. 1. The ports 28 are typically located near the bottom of the cavity 24 to ensure that any trapped water is completely drained.

Ribs 42 protruding from the inner surface 20 of the wall 18 extend from about the topmost portion 26 of the wall 18 to about the bottom of the cavity 24 in a longitudinal direction as best seen in FIGS. 2 and 4. The ribs 42 are resilient thereby allowing the ribs 42 to deform slightly when tank 11 is inserted into the cavity 24. As illustrated in FIG. 4, each of the ribs 42 comprises a tapered portion 43 near the top of the wall 18. The tapered portion 43 facilitates installing the boot 10 onto a tank 11.

Still referring to FIGS. 2 and 4, channels 44 are interposed between adjacent ribs 42. Like the ribs 42, the channels 44 extend longitudinally from about the topmost portion 26 of the wall 18 to about the bottom of the cavity 24. The channels 44 typically remain unobstructed when the boot 10 is installed onto tank 11 thereby allowing water trapped in the boot 10 after a dive to freely drain.

In FIG. 2, the upper portion 14 may have a plurality of ridges 46 running from one side of the cavity 24 to the opposite side of the cavity 24. The ridges 46 are equally spaced and run parallel to one another. A top planar surface 49 of each of the ridges 46 collectively form a deck upon which the bottom of the tank 11 installed into the cavity 24 is seated. Channels 48 are interposed between two adjacent ridges 46 and run from one side of the wall 18 to the opposite side of the wall 18 in a similar fashion to the ridges 46. The ports 28, described above, are located in the wall 18 at both ends of each of the channels 48 thereby allowing water trapped in the cavity 24 after a dive to drain to either side of the boot 10.

It will be appreciated that the channels 44 on the inner surface 20 of the wall 18 and the channels 48 on the upper portion 14 of the base member 12 in conjunction with the ports 28 allow water trapped in the boot 10 after a dive to be drained when the tank 11 is in either the vertical or horizontal direction.

Referring back to FIG. 1, the lower portion 16 of the base member 12 extends downwardly from the upper portion 14. The lower portion 16 comprises a bottommost surface 30 (see FIG. 6). The bottommost surface 30 is generally planar and engages a surface, such as the ground, to thereby maintain the tank 11 in an upright position.

An axle 34 is attached to the lower portion 16 of the base member 12. The axle 34 extends through a bore 35 (see FIG. 4) in the lower portion 16 and has a first and second ends protruding from opposite sides of the lower portion 16. It will be appreciated by those skilled in the art that the axle 34 may be attached to the lower portion 16 in a variety of manners, all of which fall within the scope of the present invention.

A pair of wheels 32 are mounted on the first and second ends of the axle 34. It will be noted that the axle 34 should be of sufficient strength to withstand the rigors of transporting the tank 11 over rough terrain. The axle 34 should also be non-corrosive in nature. In one embodiment, the axle 34 may be constructed of metal.

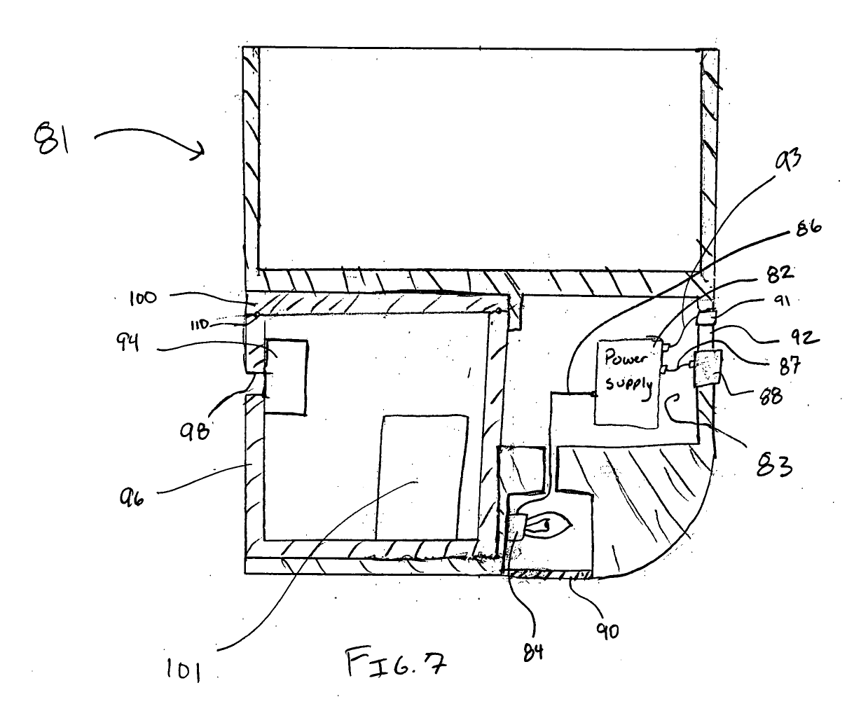

It will also be appreciated by those skilled in the art that each of the wheels 32 may be mounted onto an independent axle. Further, an axle may comprise a pair of stubs extending from the lower portion 16 of the base member 12 onto which the wheels 32 may be mounted. Some embodiments of the present invention may not have the wheels 32 or an axle 34 as is shown in FIG. 7.

In an illustrative embodiment of the invention, the wheels 32 comprise a stamp 50 to imprint a logo, graphic or text, either separately or in combination, into a soft surface, such as sand, as the wheels 32 roll along the soft surface. Stamps 50 comprising an exemplary design are shown on each of the wheels 32 in FIG. 1 and FIG. 2. It will be noted that the exemplary designs should not be construed as limiting the scope of the present invention in any way.

The lower portion 16 further comprises a skid portion 36 disposed between the wheels 32. The skid portion 36 is formed at least partially by the intersection of a sidewall 38 and the bottommost surface 30. The skid portion 36 is rounded to facilitate transporting the tank 11 across a soft surface, such as sand, mud, or dirt. It will be appreciated by those skilled in the art that the wheels 32 may sink into a soft surface, and that the rounded curvature of the skid portion 36 more easily allows the tank 11 to be dragged across the surface without gouging into the soft surface.

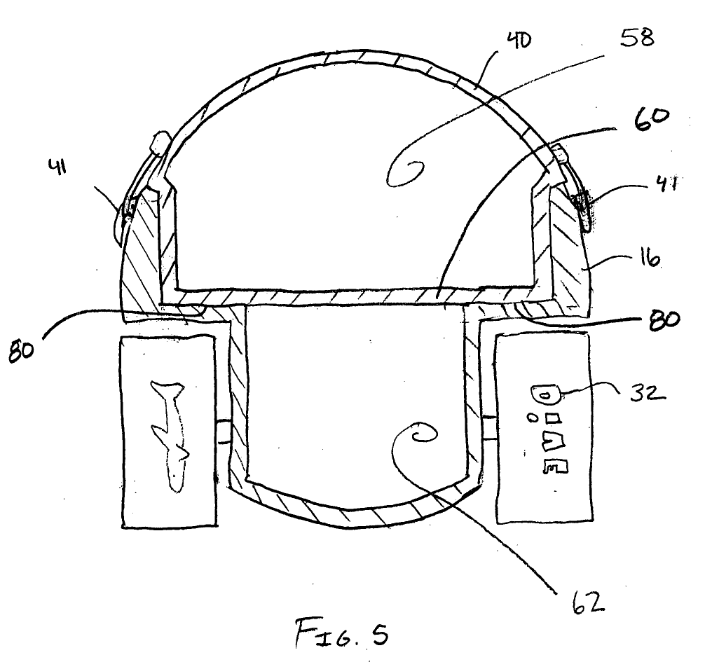

The lower portion 16 of the base member 12 further comprises a removable compartment 40, sometimes referred to herein as a drawer. The removable compartment 40 is held in place by a pair of fasteners, such as a buckle 41 type fastener. The fasteners may be disposed on opposite sides of the boot 10 to more securely hold the removable compartment 40 (see FIG. 5).

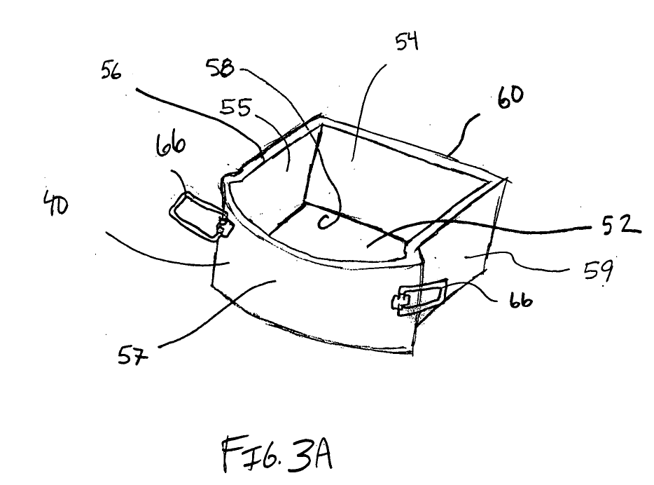

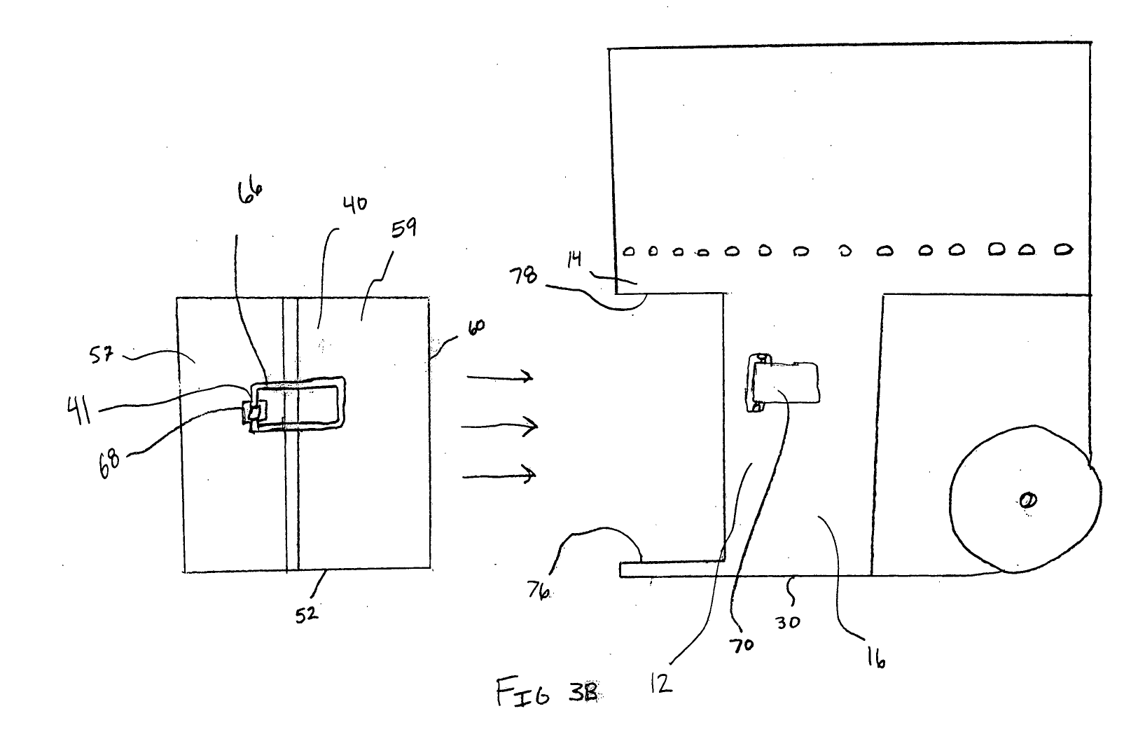

As most clearly shown in FIG. 3B, each buckle 41 may comprise a loop 66 pivotally secured to a base member 68, the base member 68 being secured to a wall 57 of the removable compartment 40. To secure the removable compartment 40, each of the loops 66 is engaged by an engaging member 70, which is disposed on the lower portion 16 of the base member 12, in an open position. The engaging members 70 are then closed thereby securing the removable compartment 40 into the lower portion 16. Other types of fasteners may include an elastic cord, velcro strip, a clasp, clamp, lock, latch, or any other type of similar device known by those skilled in the art, all of which fall within the scope of the present invention.

FIG. 3A shows a perspective view of the removable compartment 40 having a planar bottom member 52 and the wall 54, the wall 54 extending perpendicularly and upwardly from the perimeter of the planar bottom member 52. The planar bottom member 52 and the wall 54 defining a storage area 58. The wall 54 has a topmost portion 56 and a front 57, back 60, and sides 55 and 59. The front 57 of the wall 54 has a curvature matching the curvature of the wall 18 (see FIG. 1) such that when the removable compartment 40 is installed into the boot 10, the front 57 of the removable compartment 40 and the wall 18 do not extend beyond each other, but instead would maintain the cylindrical profile of the boot 10.

The back 60 of the wall 54 is generally planar. The removable compartment 40 has an open top as shown in FIG. 3A thereby allowing items to be easily placed into the removable compartment 40 when it is removed from the boot 10.

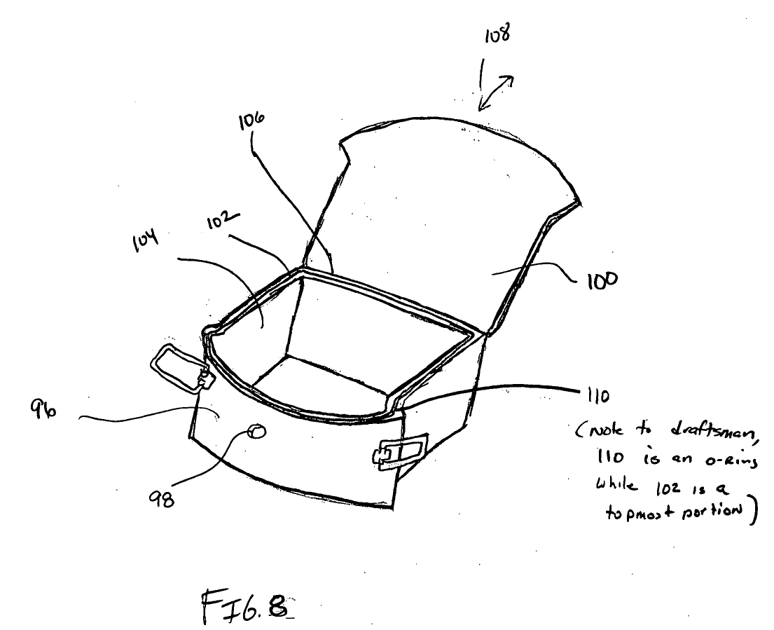

Alternatively, a removable compartment 96 may have a lid 100 as shown in FIG. 8. The lid 100 is pivotally coupled to the topmost portion 102 of a sidewall 104 along joint 106. The lid 100 may pivotally rotate as shown by double arrows 108 to open or close the removable compartment 96. A resilient member 110, such as an o-ring, may be disposed in the topmost portion 102 to form a watertight seal when the lid 100 is closed. Port 98 in the sidewall 104 allows fluid communication to a sensor inside of the compartment 96 as will be explained in further detail below.

Referring now to FIG. 3B, removable compartment 40 is received into the boot 10 between a horizontal surface 76 of the lower portion 16 and a horizontal surface 78 of the upper portion 14. As can be observed in FIG. 4, when the removable compartment 40 is installed, the topmost portion 56 of the removable compartment 40 engages the horizontal surface 78 of the upper portion 14. Likewise, the planar bottom member 52 of the removable compartment 40 engages the horizontal surface 76 of the lower portion 16. The engagement of the topmost portion 56 and the upper portion 14 may form a watertight seal to prohibit water from entering the storage area 58 while tank 11 (shown in FIG. 1) is submerged.

Referring now to FIGS. 4 and 5, compartment 62 is integrally formed in the lower portion 16. The upper portion 14 forming the top of the compartment 62 and the lower portion 16 defining the rest of the compartment. The compartment 62 is located in the lower portion 16 such that it can only be accessed through an opening 64 when the removable compartment 40 is removed from the boot 10. The compartment 62 is further located above the axle 34 and between the wheels 32.

Due to its location, the removable compartment 40 serves as a door to the compartment 62. It will be noted that any type of door may be employed to enclose the compartment 62. The rearmost portion 60 of the removable compartment 40 may form a watertight seal around the opening 64 by engaging a vertical surface 80 of the lower portion 16 when the removable compartment 40 is installed into the boot by engaging the lower portion 16 as shown in FIGS. 4 and 5.

Compartment 72 is located between a transparent portion 74 of the bottom surface 30 and the planar bottom member 52 of the removable compartment 40. The planar bottom member 52 of the removable compartment 40 functions as a door to gain access to the compartment 72. When the removable compartment 40 is installed into the boot 10, the compartment 72 typically cannot be accessed. The planar bottom member 52 of the removable compartment 40 may seal water tightly from the compartment 72 by engaging the horizontal surface 76 of the lower portion 16.

In FIG. 6, the transparent portion 74 forming at least part of the bottommost surface 30 of the lower portion 16 can be observed. It will be appreciated that a printed insert placed into the compartment 72 will be externally viewable through the transparent portion 74. The printed insert may comprise an advertisement, personal information, dive shop information, first aid information, emergency information, animal identifiers, logos, or decorative designs.

In FIG. 7, a power supply 82 located in compartment 83 is shown connected to a light source 84 by an electrical path 86 in an alternative embodiment of a tank boot 81 in accordance with the principles of the present invention. The power supply 82 is controlled by a switch 88 mounted in a sidewall 92 of the tank boot 81 thereby allowing the light source 84 to be turned on and off. The power supply 82 may comprise batteries.

Switch 88 may be a manual switch or may have a sensor to automatically turn on the light source 84 when the boot 81 is submerged. Electrical path 87 connects the switch 88 and the power supply 82. An external plug 91 connected to the power supply 82 by electrical path 93 may allow external electrical accessories (not shown) to be connected to the power supply 82.

A transparent portion 90 allows light from the light source 84 to be externally viewed. It will be appreciated that the light source 84 allows divers to keep track of each other while diving, especially in low light conditions.

FIG. 7 also shows a sensor 94 mounted into a removable compartment 96. The sensor 94 is in direct fluid communication with the outside of the removable compartment 96 through a port 98 in the sidewall 92. It will be appreciated that the sensor 94 may monitor and record information about a dive, including, without limitation, length of time submerged, depth information, including the time spent at each depth, and water temperature.

As discussed above, lid 100 is provided for the removable compartment 96. The lid 100 is held tightly in abutment with the topmost portion 102 and the resilient member 110 when the removable compartment 96 is installed into the boot 81. In this manner, the interior of the compartment 96 remains dry during a dive.

Useful items 101 are shown in the removable compartment 96 which may include, without limitation, a first aid kit, spare parts for a tank upon which the boot 81 is installed, and a tool kit. Useful items 101 may also include a transmitter for sending out a signal. This may be useful to allow a dive master with a receiver to know that divers are still underwater, as divers have been left stranded at remote dive locations in the past.

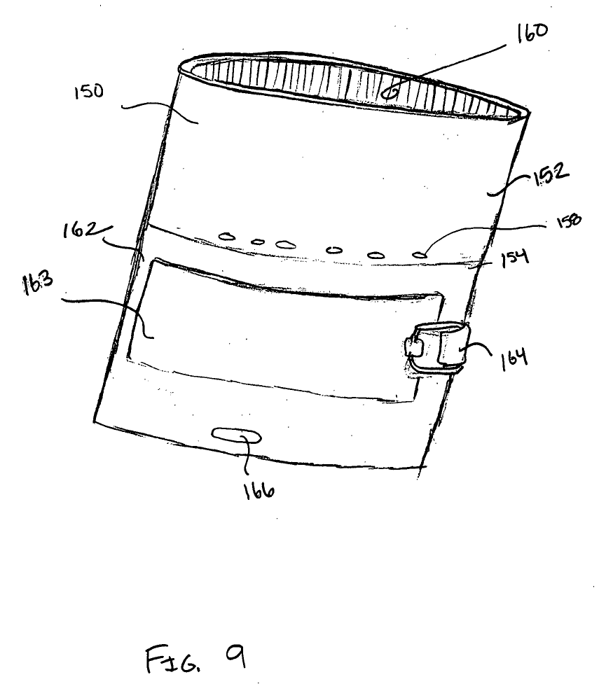

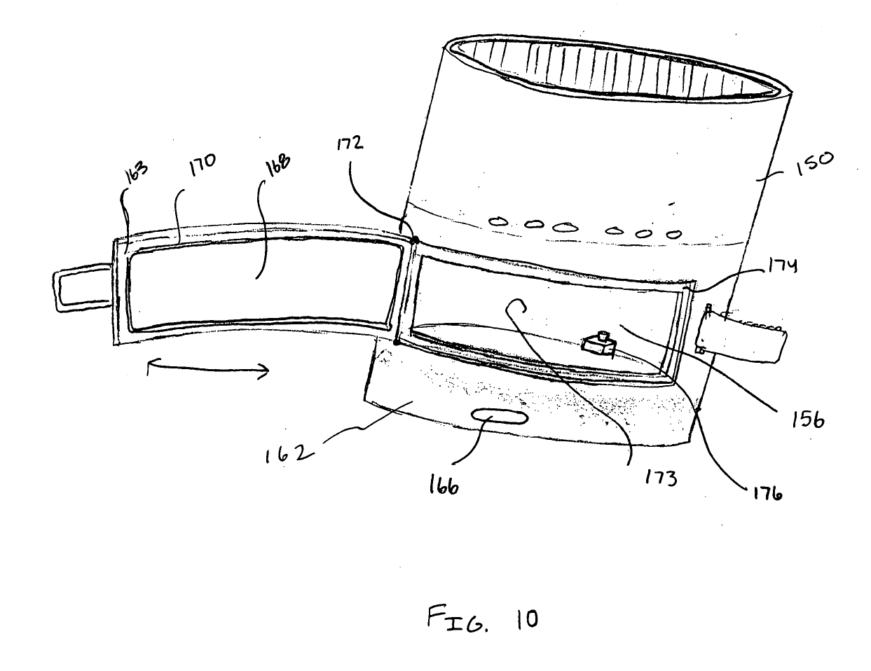

A tank boot 150 having a wall 152 extending upwardly from an upper portion 154 is shown in FIG. 9. Wall 152 may engage a lower portion of a tank (not shown) as previously described. Ports 158 allow drainage from a cavity 160 formed by the wall 152 after a dive. Lower portion 162 comprises a water tight compartment 156 (best seen in FIG. 10) sealed by a door 163. Door 163 is operable between a closed position and an open position. Door 163 is maintained in a closed position by fastener 164. Lower portion 162 also comprises a light source 166.

Door 163 opens to allow access to compartment 156, as shown in FIG. 10. Door 163 is curved in order to maintain the overall cylindrical profile of tank boot 150 when the door 163 is closed. Door 163 comprises an inner side 168 that faces into the compartment 156 when the door 163 is in the closed position. Door 163 is attached to lower portion 162 by a hinge 172. It will be appreciated that hinge 172 may be one of many types of hinges known in the art. A resilient member 170, such as an o-ring, is disposed on the inner side 168 of door 163.

The lower portion 162 comprises an opening 173 leading to compartment 156. A recessed surface 174 circumscribes opening 173. The recessed surface 174 engages resilient member 170 on the door 163 when the door 163 is in the closed position. In this manner, a watertight seal is formed to prevent water from entering compartment 156 during a dive.

A switch 176 is disposed inside compartment 156 to control the light source 166. It will be appreciated that placing the switch 176 inside the compartment 156 allows the light source 166 to be conveniently turned ON before a dive by simply opening the door 163 and toggling the switch 176. After a dive, the light source 166 may be turned OFF in the same manner.

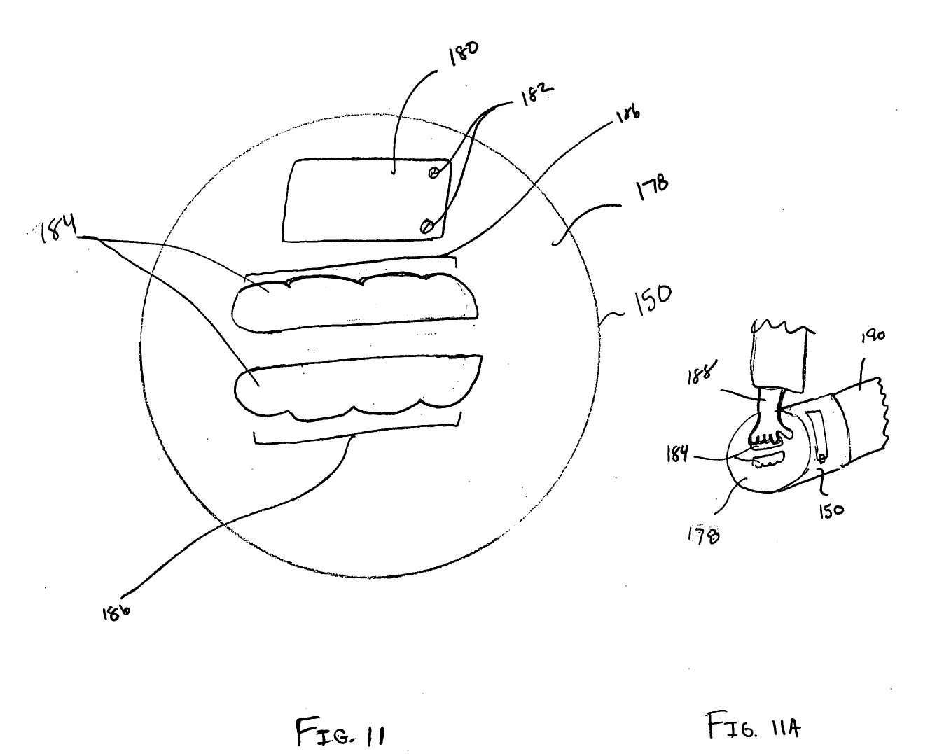

As shown in FIG. 11, the bottommost surface 178 of tank boot 150 comprises a lid 180 secured to the bottommost surface 178 by screws 182. Lid 180 allows access to a battery compartment (not shown) containing replaceable or rechargeable batteries (also not shown). The batteries power light source 166 as controlled by switch 176 (see FIG. 10). The bottommost surface 178 further comprises hand slots 184 that provide an integrated handle for allowing a person carrying a tank to have a secure grip. Slots 184 each have a contoured portion 186 adapted to comfortably receive a user's hand 188 as shown in FIG. 11A.

FIG. 11A illustrates the user's hand 188 holding tank 190 mounted on tank boot 150 by gripping one of the slots 184. As can be observed, the fingers on hand 188 are inserted into one of the slots 184. The slots 184 should be of sufficient depth to allow the fingers to easily grasp the boot 150. The dual slots 184 allow the tank 190 to be carried regardless of the orientation of the tank 190. It should be noted, that a handle may be integrated into tank boots with wheels as well.

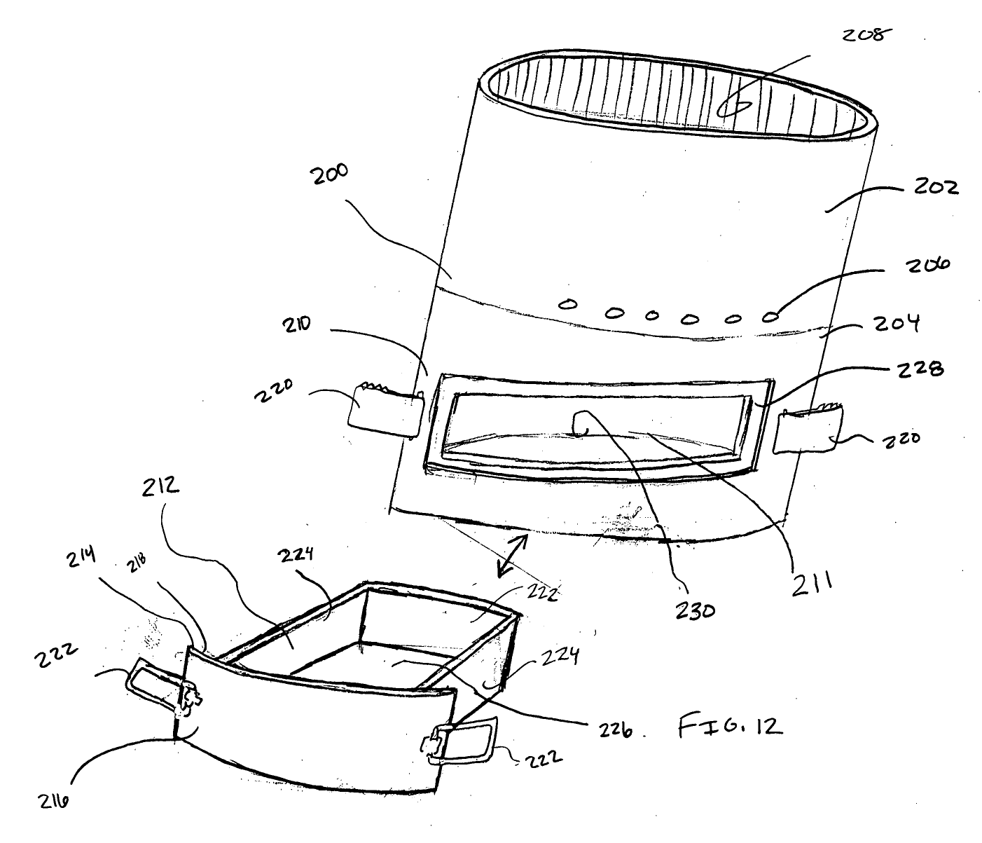

A tank boot 200 having a wall 202 extending upwardly from an upper portion 204 is shown in FIG. 12. Wall 202 may engage a lower portion of a tank (not shown) as previously described. Ports 206 allow drainage from a cavity 208 formed by the wall 202 after a dive. Lower portion 210 comprises a compartment 211 for receiving a removable compartment 212. The removable compartment 212 has a front 214 comprising an outer and inner surface, 216 and 218 respectively, a back 222, sides 224 and a bottom 226. The removable compartment 212 is secured in place by fasteners 220 for engaging loops 222 coupled to the front 214 of removable compartment 212.

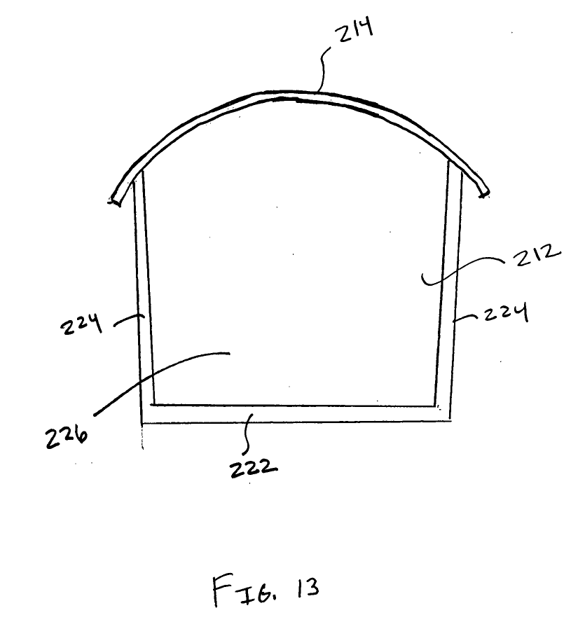

FIG. 13 is a top view of removable compartment 212. The front 214 of removable compartment 212 is curved to maintain the overall profile of the tank boot 200 when the removable compartment 212 is installed. Sides 224 are substantially parallel and extend between the front 214 and the back 222 of the removable compartment 212. Bottom 226 forms the bottom of the removable compartment 212.

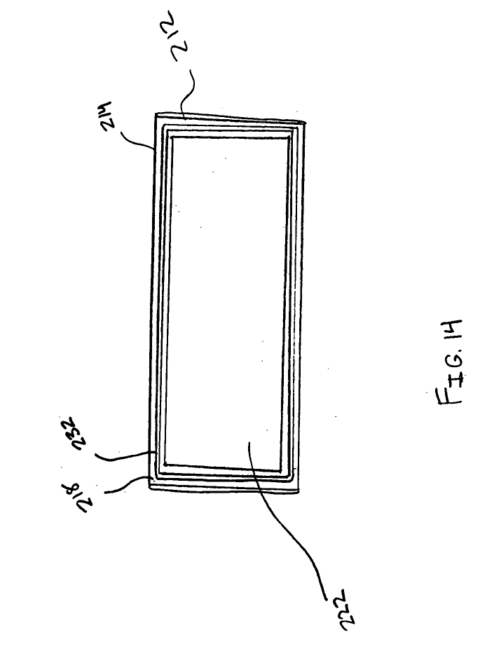

FIG. 14 is a rear view of removable compartment 212. A resilient member 232 is disposed in the inner surface 218 of the front 214 of the removable compartment. When the removable compartment 212 is inserted into an opening 230 leading to compartment 211 (see FIG. 12), the resilient member 232 forms a watertight seal by engagement with a recessed surface 228 circumscribing the opening 230. Fasteners 220 secure removable compartment 212 into compartment 211 and further enhance the watertight seal by more tightly compressing the resilient member 232 against the recessed surface 228.

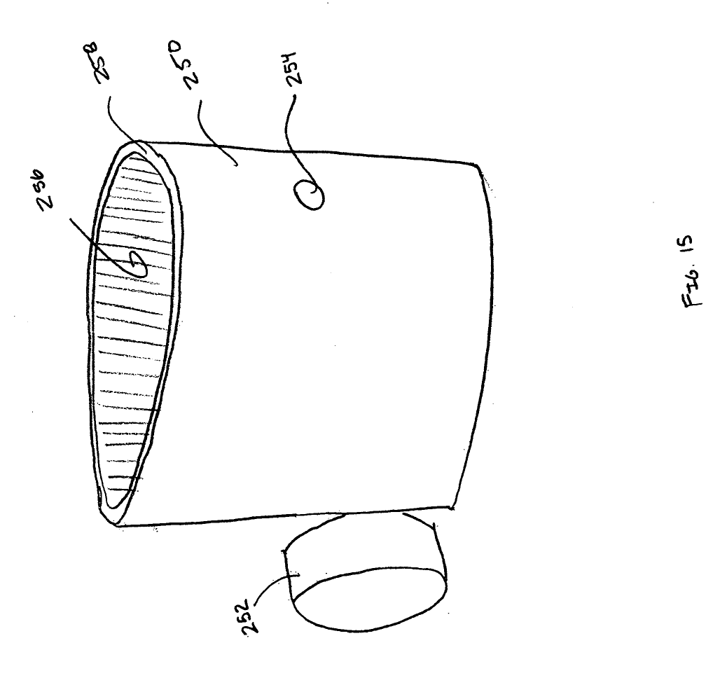

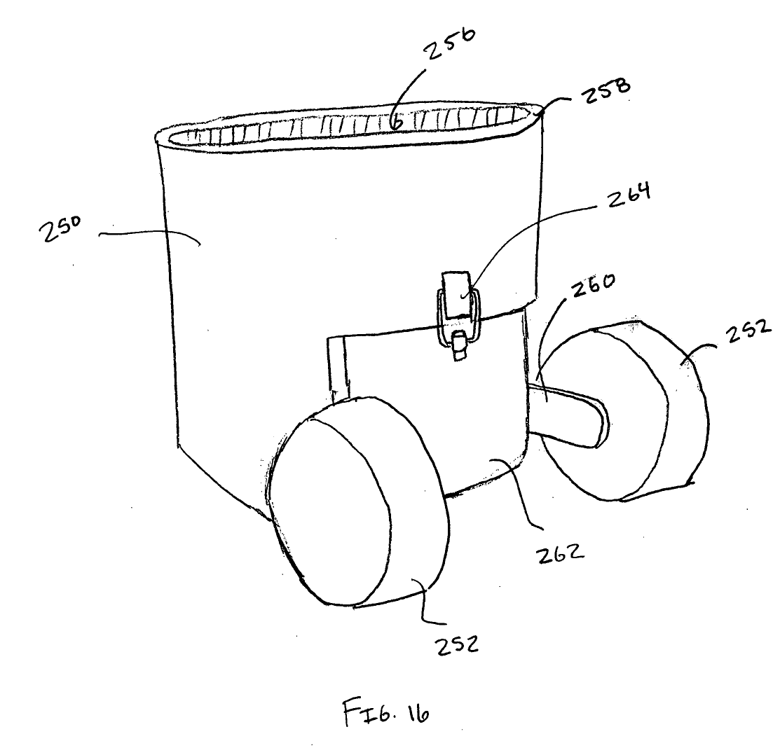

Another embodiment of a tank boot 250 having retractable wheels 252 is shown in FIGS. 15-18. Referring now to FIGS. 15 16 and 17, a cavity 256 for receiving a lower portion of a tank (not shown) is formed by a wall 258. A compartment 262 for storage is received into the tank boot 250 and is held in place by fastener 264. The compartment 262 may be transparent or have a transparent portion thereby allowing the interior contents to be observed. Each of the wheels 252 is mounted on an arm 260 extending from the tank boot 250. Each of the arms 260 is pivotally mounted to the tank boot 250. When extended, the arms 260 and wheels 252 provide a more stable support for the tank boot 250 by providing a wider distance between wheels 252 and the tank boot 250 than would typically be possible with out the extension.

When the arms 260 are extended, the tank boot 250 may still stand upright and may act to prevent the tank (not shown) from toppling over. The arms 260 lock in place when in the extended and retracted position. The arms 260 may be released from either position by depressing mechanical release 254 (see FIG. 15).

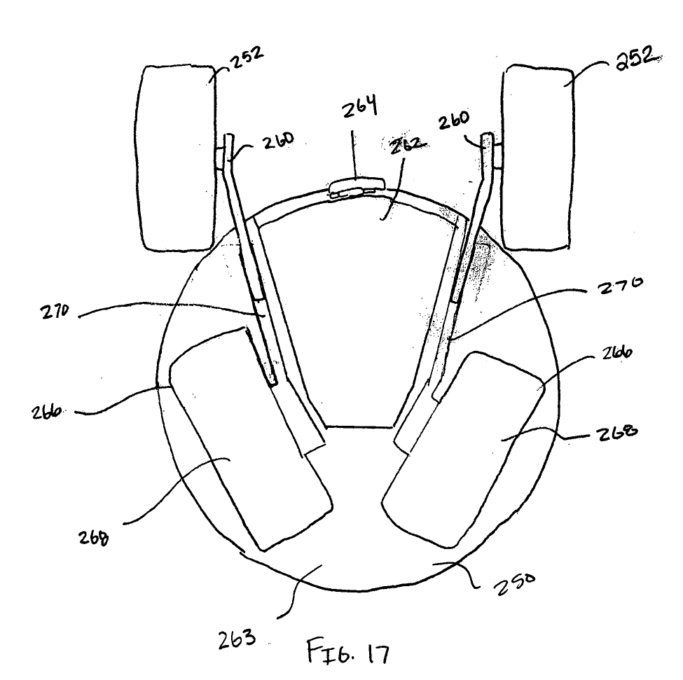

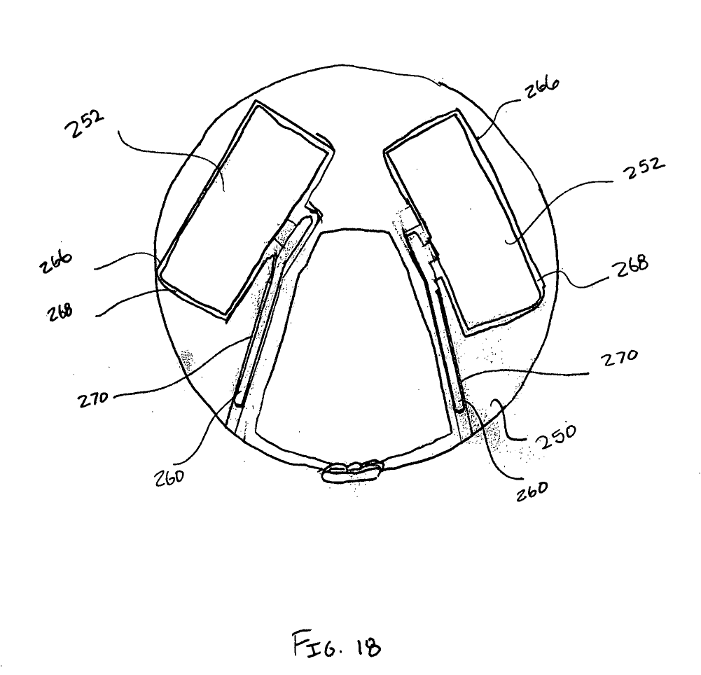

Referring now to FIGS. 17 and 18, wells 266 formed in the bottom 263 of the tank boot 250 are adapted to receive the arms 260 and wheels 252 into an arm portion 270 and a wheel portion 268, respectively, of the wells 266 when the arms 260 and wheels 252 are retracted. The wheels 252 are extended to facilitate transporting the tank (not shown). As shown in FIG. 18, the arms 260 and wheels 252 may be retracted during a dive or during storage. When retracted, the arms 260 and wheels 252 should not prevent the boot 250 from being able to stand upright and, therefore, should be entirely contained in wells 266.

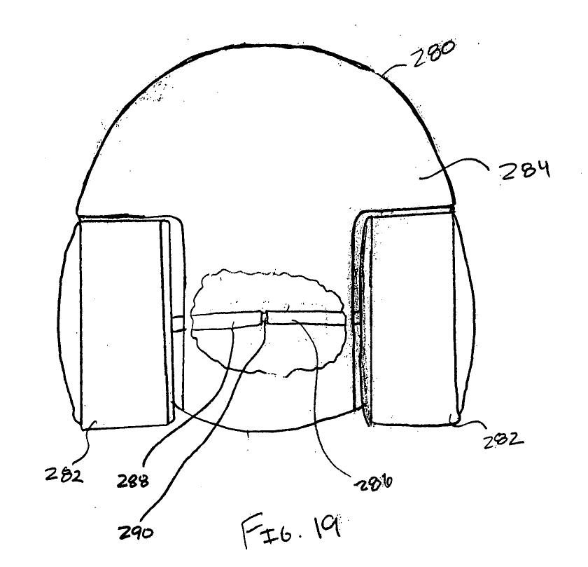

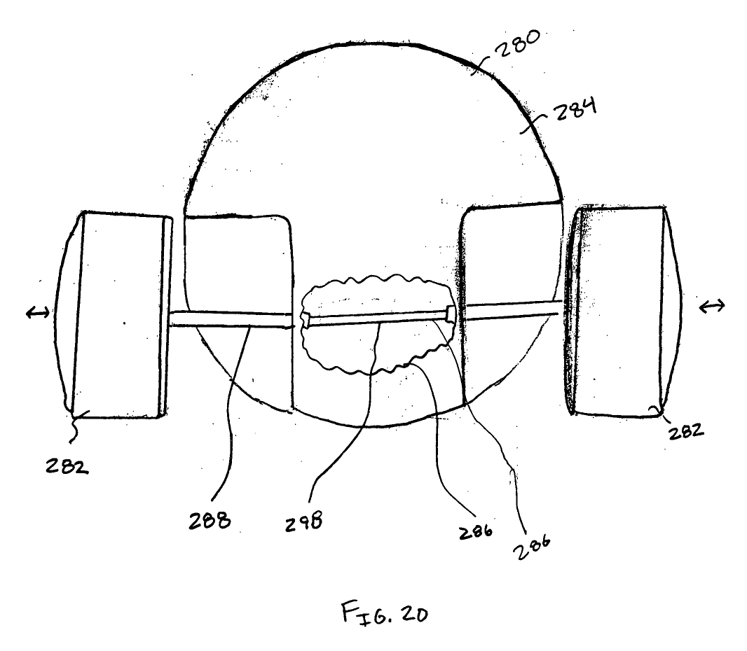

FIGS. 19 and 20 show still another embodiment of a tank boot 280 having wheels 282 operable between a retracted position as shown in FIG. 19 and an extended position as shown in FIG. 20. As can be seen through the cut away portion, axle 286 comprises an outer portion 288 and an inner portion 290. The outer portion 288 and the inner portion 290 of the axle 286 are movable with respect to each other in a telescoping manner. This configuration allows the wheels 282 to be used in either the retracted position as shown in FIG. 19 or the extended position as shown in FIG. 20.

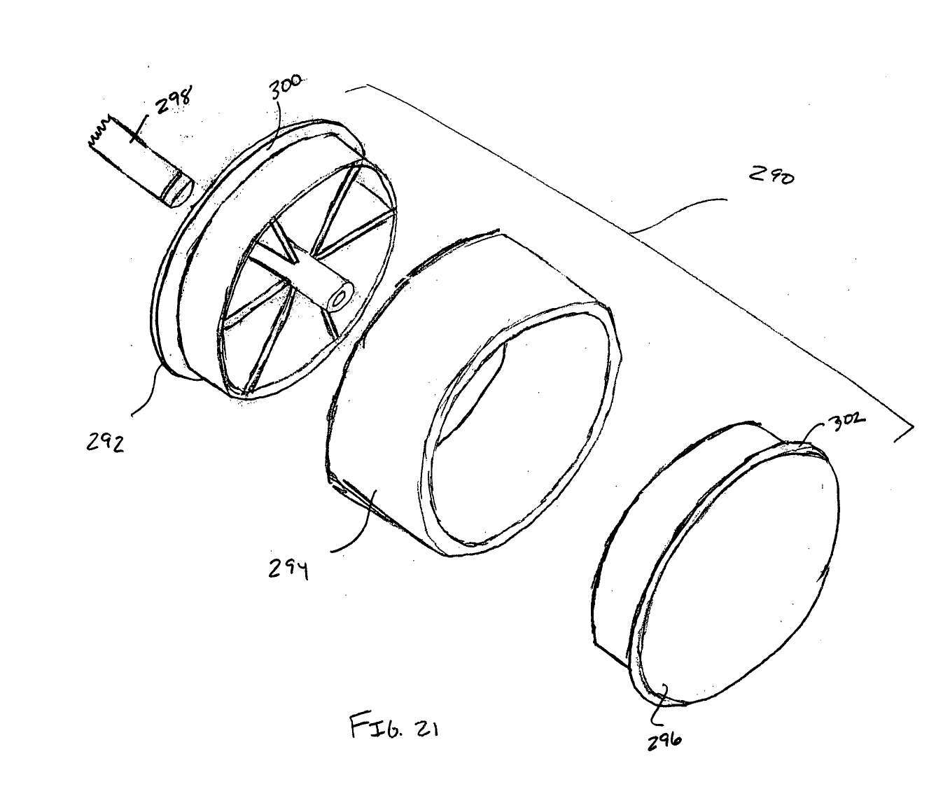

FIG. 21 shows a wheel assembly 290 comprising a housing 292, a tread 294 and a cap 296. The housing 292 is installed onto axle 298, which may be done with a retaining ring (not shown). Tread 294 is secured between wall 300 on the housing 292 and wall 302 on the cap 296. Cap 296 and housing 292 are held together by a snap fit. It will be appreciated that this configuration allows tread 294 to be molded flat.

It will be noted, that in the various embodiments of the present invention that may be deployed on scuba tanks, the storage compartments may be watertight to thereby maintain items stored therein dry throughout the dive. Other embodiments of the present invention may not require the storage compartments to be watertight. As mentioned, the storage compartments may be used to store a wide range of items, including a power supply, first aid kit, tool kit, spare parts for the tank, or personal items, such as keys, wallets or cellular phones.

The tank boot of the present invention can be made of a variety of materials. Advantageously, however, tank boot can be made by molding plastics, according to methods well known in the art.

Those having ordinary skill in the relevant art will appreciate the advantages provided by the features of the present invention. For example, it is a feature of the present invention to provide a tank boot having one or more compartments, some or all of which may be watertight. Another feature of the present invention is to provide a wheeled tank boot having a skid portion to facilitate transport across soft surfaces. It is a further feature of the present invention, in accordance with one aspect thereof, to provide a tank boot that may be drained in the horizontal or vertical position. It is still another feature of the present invention to provide a tank boot having a light source located in the tank boot to assist divers in keeping track of one another.

It should be noted that a tank boot in accordance with the principles of the present invention may be manufactured in different colors or even of transparent material. If the boot is transparent, then items in the compartments are externally visible. As used herein, the term transparent means transparent and translucent, i.e., permitting the passage of light in any amount.

In the foregoing Detailed Description, various features of the present disclosure are grouped together in single embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A device attachable to a bottom end of a cylindrical tank, said device comprising:
a base member having an upper portion and a lower portion;
a wall extending from the upper portion of the base member such that the wall and the upper portion of the base member define a cavity configured for receiving the bottom end of the cylindrical tank; and
a first storage compartment disposed in the base member.

2. The device of claim 1 wherein the upper portion of the base member defining the cavity comprises a plurality of channels and ridges.

3. The device of claim 2 wherein the wall comprises an inner surface comprising a plurality of channels and ribs disposed thereon.

4. The device of claim 3 wherein the wall comprises an outer surface and the device further comprises a plurality of ports extending from the inner surface of the wall to the outer surface of the wall.

5. The device of claim 4 wherein the lower portion comprises a substantially planar bottommost surface configured for maintaining the cylindrical tank in an upright position.

6. The device of claim 5 further comprising first and second wheels mounted on an axle attached to said lower portion.

7. The device of claim 1 further comprising first and second wheels mounted on an axle attached to said base member.

8. The device of claim 7 wherein the lower portion further comprises a skid portion disposed between the first and second wheels.

9. The device of claim 7 wherein the base member comprises a bore therethrough, and the axle is disposed in the bore.

10. The device of claim 1 wherein the first storage compartment is configured for being watertight.

11. The device of claim 10 further comprising a second storage compartment disposed on the base member.

12. The device of claim 11 wherein the second storage compartment is configured for being watertight.

13. The device of claim 1 wherein the first storage compartment comprises a drawer.

14. The device of claim 13 further comprising at least one fastener for securing the drawer to the base member.

15. The device of claim 14 wherein the drawer is removable from the base member.

16. The device of claim 15 wherein the first storage compartment is configured for being watertight when installed on the base member.

17. The device of claim 13 wherein the drawer comprises a lid.

18. The device of claim 13 further comprising a second storage compartment disposed in the base member.

19. The device of claim 18 wherein the base member is configured such that the second storage compartment is accessible only when the drawer is removed from the base member.

20. The device of claim 19 wherein the drawer comprises a rearmost portion, which seals the second storage compartment in a watertight manner when the drawer is installed on the base member.

21. The device of claim 20 further comprising first and second wheels mounted on an axle attached to said base member and a skid portion disposed between the first and second wheels.

22. The device of claim 21 wherein at least one of the wheels comprises an outer surface comprising a stamp for imprinting as the at least one wheel rolls across a soft surface.

23. The device of claim 22 wherein the stamp comprises one or more of text, a logo, or a design.

24. The device of claim 1 further comprising a power supply disposed in the first storage compartment.

25. The device of claim 24 further comprising a light source, wherein the power supply is in electrical communication with the light source.

26. The device of claim 25 further comprising a switch for controlling the light source.

27. The device of claim 26 wherein the switch automatically controls the light source.

28. The device of claim 24 wherein the base member further comprises a plug for powering an external electrical device, wherein said plug is in electrical communication with the power source.

29. The device of claim 1 further comprising a first aid kit disposed in the first storage compartment.

30. The device of claim 1 further comprising a tool kit disposed in the first storage compartment.

31. The device of claim 1 further comprising spare parts for the cylindrical tank disposed in the first storage compartment.

32. The device of claim 1 further comprising a transmitter or a sensor disposed in the first storage compartment.

33. The device of claim 1 further comprising a door operable between a first position and a second position, and wherein the first storage compartment is accessible when the door is in the first position and watertight when the door is in the second position.

34. The device of claim 33 wherein the door further comprises a resilient member for forming a watertight seal.

35. The device of claim 33 wherein the door is coupled to the base member with a hinge.

36. The device of claim 33 wherein the door is detachable from the base member.

38. The device of claim 33 further comprising a fastener, said fastener securing the door in the second position.

39. The device of claim 10 further comprising a handle.

40. A device attachable to a bottom end of a cylindrical tank, said device comprising:
a base member having an upper portion and a lower portion, the lower portion comprising a first storage compartment and a transparent portion; and
a wall extending from the upper portion of the base member such that the wall and the upper portion of the base member define a cavity configured for receiving the bottom end of the cylindrical tank;
wherein items placed in the first storage compartment are externally visible through the transparent portion of said lower portion of the base member.

41. The device of claim 40 further comprising first and second wheels mounted on an axle attached to said lower portion.

42. The device of claim 41 wherein the lower portion further comprises a skid portion disposed between the first and second wheels.

43. The device of claim 40 wherein the first storage compartment is configured for displaying indicia.

44. The device of claim 40 further comprising a power supply disposed in the base member.

45. The device of claim 44 further comprising a light source in electrical communication with the power supply, said light source disposed in the first storage compartment, wherein light emanating from the light source is externally visible through the transparent portion.

46. The device of claim 45 further comprising a switch for controlling the light source.

47. The device of claim 40 wherein the lower portion of the base member comprises a bottommost surface, said bottommost surface comprising the transparent portion, and the device further comprises a second storage compartment disposed on the base member, the second storage compartment comprising a drawer having a bottom surface, the first storage compartment being positioned between the bottom surface of the drawer and the bottommost surface of the lower portion.

48. The device of claim 47 wherein the drawer is removable.

49. The device of claim 40 wherein the lower portion of the base member further comprises a bottommost surface, said bottommost surface comprising at least partially the transparent portion.

50. The device of claim 40 wherein the base member is comprised of a transparent material.

51. The device of claim 40 further comprising a door operable between a first position and a second position, and wherein the first storage compartment is accessible when the door is in the first position and watertight when the door is in the second position.

52. The device of claim 40 wherein the first storage compartment is removable.

53. The device of claim 52 wherein the first storage compartment comprises the transparent portion.

54. A device attachable to a bottom end of a cylindrical tank, said device comprising:
a base member having an upper portion and a lower portion;
a wall extending from the upper portion of the base member such that the wall and the upper portion of the base member define a cavity configured for receiving the bottom end of the cylindrical tank; and
a pair of wheels connected to the lower portion, each of said pair of wheels movable between a first position and a second position.

55. The device of claim 54 further comprising a storage compartment.

56. The device of claim 54 further comprising a pair of arms attached to the lower portion, each of the pair of wheels being mounted on one of the pair of arms.

57. The device of claim 56 wherein each of the pair of arms is pivotally engaged to the lower portion.

58. The device of claim 57 further comprising wheel wells adapted to receive the pair of wheels.

59. The device of claim 54 further comprising an axle attached to the lower portion, each of the pair of wheels being mounted on the axle.

60. The device of claim 59 wherein the axle is extendable in a longitudinal direction.

61. A device attachable to a bottom end of a cylindrical tank, said device comprising:
a base member having an upper portion and a lower portion;
a wall extending from the upper portion of the base member such that the wall and the upper portion of the base member define a cavity configured for receiving the bottom end of the cylindrical tank; and
a light source disposed in the base member.

62. The device of claim 61 further comprising a power supply for said light source.

63. The device of claim 62 further comprising a switch for controlling said light source.

64. The device of claim 63 wherein the base member further comprises a watertight storage compartment.

65. The device of claim 64 further comprising a pair of wheels.

66. The device of claim 65 wherein the wheels are movable between a first position and a second position.

67. A device attachable to a bottom end of a scuba tank, said device comprising:
a base member having an upper portion and a lower portion;
a wall, comprising an inner surface and an outer surface, the wall extending from the upper portion of the base member such that the wall and the upper portion of the base member define a cavity configured for receiving the bottom end of the scuba tank;
a plurality of channels disposed on the inner surface of the wall;
a plurality of ports each extending from the inner surface to the outer surface of the wall, and a plurality of channels disposed in the upper portion of the base member for allowing water to drain out of the cavity through the plurality of ports;
first and second wheels mounted on an axle attached to said lower portion, an outer surface of at least one of the wheels having a stamp for imprinting;
a skid portion of the lower portion disposed between the first and second wheels;
a bottommost surface of the lower portion configured for maintaining the scuba tank in an upright position;
a first watertight storage compartment comprising a drawer slidably received into the lower portion;
a fastener for securing the drawer to the lower portion; and
a second watertight storage compartment disposed in the lower portion and accessible only when the drawer is removed from the lower portion.
